(19) United States
(12) Patent Application Publication
(10) Pub. No.: US 2007/0077838 A1
(43) Pub. Date: Apr. 5, 2007

(54) Multiple layer roofing underlayment material

(76) Inventors: Jesse Alvin Binkley, Midlothian, TX (US); Younger Ahluwalia, Desoto, TX (US); Louis T. Hahn, Waxahachie, TX (US); Margie A. Beerer, Ennis, TX (US)

Correspondence Address: BAKER & BOTTS L.L.P., 30 ROCKEFELLER PLAZA, 44TH FLOOR, NEW YORK, NY, 10112-4498, US

(21) Appl. No.: 11/528,934

(22) Filed: Sep. 28, 2006

Related U.S. Application Data
(60) Provisional application No. 60/722,262, filed on Sep. 30, 2005.

(51) Int. Cl. B32B 5/26; B32B 27/12

(52) U.S. Cl. 442/286; 442/239; 442/268; 442/401; 442/382

(57) ABSTRACT

A multiple-layered roofing underlayment material comprising an inner core providing a continuous film water barrier, a first outer layer comprising a woven or spun bond fabric, and a second outer layer comprising a woven or spun bond fabric, wherein the inner core binds the first outer layer to the second outer layer.

### PRIORITY AND RELATED APPLICATION

This application claims priority to U.S. Provisional Application No. 60/722,262 filed on Sep. 30, 2005, which is hereby incorporated by reference in its entirety.

### BACKGROUND OF INVENTION

Traditional roofing underlayment, such as conventional 30# asphaltic felt has relatively low elongation properties, i.e., poor stretch resistance, because it is built around a paper felt. There exists a need to provide a roofing underlayment material that provides stretch resistance, low cost, and advantageous physical properties including water resistance, sufficient roof deck grip, light weight, and cool working surface.

### SUMMARY OF INVENTION

This invention relates to a roofing underlayment material comprising an inner core positioned between a number of outer layers. The roofing underlayment of the present invention can be used in the same manner as conventional asphaltic felt, such as for example, 30# asphaltic felt.

It is an object of the present invention to provide a superior material that can be used as a roofing underlayment to provide leak protection, reflectivity with modest ultraviolet (“UV”) resistance on one side, and non-reflectivity with high UV resistance on the other. In a preferred embodiment, the reflective side of the material provides a working surface that may be 30° F. to 50° F. cooler than conventional asphaltic felt.

It is a further object of the present invention to provide a material that has improved anti-slip walkability that will not stick when rolled up. Another object of the present invention is to provide a roofing underlayment material that has reduced wrinkle and deformation properties under a wide range of temperatures and loads, as well as being stretch resistant and tear resistant in high winds.

### BRIEF DESCRIPTION OF THE DRAWINGS

FIG. 1 is a three dimensional elevated view of a multiple layer roofing underlayment material.

### DETAILED DESCRIPTION

The present invention relates to a multiple layer roofing underlayment material with a thermoplastic core layer positioned between a number of outer layers. An outer layer of the underlayment consists preferably of a woven fabric comprising polypropylene with a fabric weight as low as 70 grams/m². Materials of heavier or lower weight can also be used.

The inner core of the underlayment acts as a binder for the outer layers and provides water resistance through the use of a thermoplastic, resinous, wax, or polymeric material. Numerous materials can be used to provide a continuous film water barrier inner core, such as asphalt, polyethylene terephthalate (PET), polyvinyl chloride (PVC), pine pitch, polypropylene, polyethylene, polyamides, polyester, and nylon. In the preferred embodiment, the inner core is a thermoplastic comprising asphalt because of the advantageous features associated with its physical properties, processability, and inexpensive cost. Asphalt's low cost allows for the efficient application of a sufficient film thickness in order to provide for good quality body, or a product that has a heavy canvas feel and adequate stiffness. Further, asphalt is a readily available material. Blown and unblown grades can be used including Types 1, 2, 3 and 4, which can be mixed in any desired ratio.

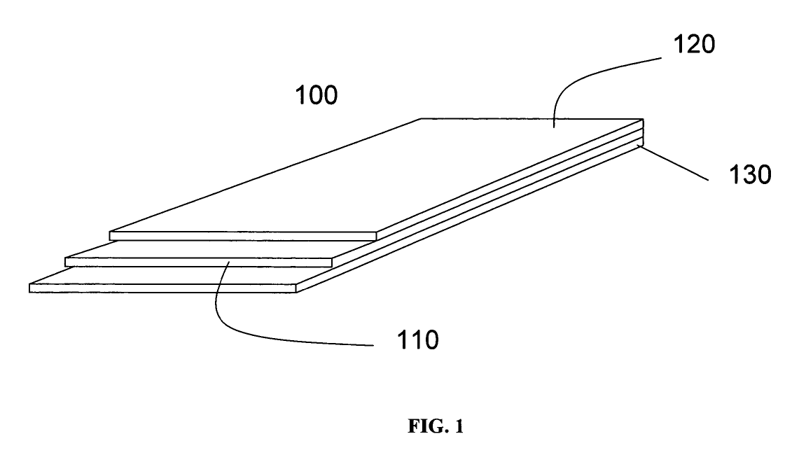

Referring to FIG. 1, an outer layer 120 of the underlayment consists of a spun bond fabric layer. The spun bond fabric layer, when combined with an inner core 110 and a woven fabric outer layer 130, forms a three-layer underlayment material 100. A plurality of outer layers of either non-woven, e.g., spun bond, fabric or woven fabric can be used to produce a multi-layered underlayment material. Because the spun bond layer is not needed to provide strength to the product, it can be very light-weight material, such as 43 grams/m² or less.

A woven fabric outer layer can be used for the upper and/or the lower layer, and spun bond fabric can be used for the upper and/or lower layer. One of the layers is preferably woven to ensure that the underlayment has good strength characteristics, and one of the layers is preferably a spun bond or other type of non-woven fabric. When used as a lower layer, the spun bond fabric layer provides good grip to the roof deck. The thermoplastic inner core can be positioned between two or more layers of either woven fabric or spun bond fabric, or any combination thereof. For example, the underlayment material may comprise a woven fabric/thermoplastic core/woven fabric arrangement; a spun bond fabric/thermoplastic core/spun bond fabric arrangement; or a woven fabric/thermoplastic core/spun bond fabric arrangement.

The inner core ideally provides dimensional stability, nail sealability, and heat dissipation. By utilizing a thermoplastic core having a relatively low softening point, the underlayment has sufficient low temperature flexibility to prevent cracking when subjected to normal installation and usage conditions. At the same time, the inner core is comprised of materials with sufficiently high softening point to prevent unwanted flow of the core materials at elevated temperatures.

The inner core can be modified to increase stiffness or decrease density by introducing organic and inorganic fillers, blowing agents, fibers, solid or hollow microspheres, natural and synthetic pulps and fibers, and adhesion modifiers as will be appreciated by one of skill in the art. In a further embodiment, the inner core can be comprised of blown or unblown asphalt, and modified with such materials as styrene-butane rubber, SEBS, plasticizers, oils and other materials or processes to provide desired nail seal properties, flow characteristics at elevated temperatures, and flexibility at low temperatures. The inner core is bound on the upper and lower surfaces between any combination of woven, spun bond, needle punch fabrics or continuous polymeric or resinous films.

The upper layer of the underlayment can be used as the upper tread or walking surface. The walking surface has anti-slip footing characteristics, is resistant to tears and breakage, and provides for adequate dimensional stability. The fabric used for the walking surface is preferably comprised of woven fabric, or it can be spun bond or needle punched in such a manner to provide a weave, spin or filament distribution pattern that effectively protects the inner core. The surface is also sufficiently photochemically stabilized to ensure adequate outdoor weather exposure performance, or to allow unimpeded environmental degradation while maintaining acceptable performance characteristics. The upper layer may also be comprised of polypropylene, polyethylene, PVC, PET, nylon, or other synthetic or natural fabrics that can be woven or non-woven.

The lower surface of the underlayment is preferably comprised of a spun bond material, but may also include woven, needle punch, or other fabrics and films. This outer layer further provides a surface that provides for adequate deck gripping. The lower layer may also be comprised of polypropylene, polyethylene, PVC, PET, nylon, or other synthetic or natural fabrics that can be woven or non-woven.

The roofing underlayment material of the present invention provides dimensional stability, resists wrinkling, provides for anti-slip footing, has sufficient deck-grip, is robust and wind resistant—meaning it will resist tearing due to high wind—and provides for easy cutting with, for example, a hook-knife.

In a preferred embodiment of the invention, the underlayment consists of a woven polypropylene (“PP”) outer layer fabric that is very light or white in color and a spun bond outer layer fabric that is pigmented very dark or black. The outer layers are bonded together by a thermoplastic core. The woven fabric has a relatively high reflectivity with modest ultraviolet (“UV”) resistance, while the spun bond fabric is substantially non-reflective and has relatively high UV resistance. The underlayment may be installed woven-side-up to provide a highly-reflective roof surface that provides a working surface that may be 30° F. to 50° F. cooler than conventional asphaltic felt. In a temperature comparison between a sample of the inventive underlayment and 30# felt, measurements were taken at five evenly-spaced locations forming a pentagon about the perimeter of each test specimen. The first measurement is the uppermost or 12:00 position and the locations proceed clockwise. The results were as follows:

| New Underlayment | 30# Felt Underlayment |
|---|---|
| 107° F. | 147° F. |
| 103 | 151 |
| 106 | 143 |
| 105 | 136 |
| 105 | 152 |

The maximum difference observed was 48° F. The average difference was 40.6° F.

In one sample of this preferred embodiment, the light and dark sides of the inventive underlayment were measured using a Mircro-Gloss 60 (BYK-Gardner) at 60 degrees and found to have values of 10.2 gloss units (GU) and 1.1 GU, for the light side and dark side, respectively. Using a MiniScan XE Plus calorimeter (Hunter Associates Laboratories) the L* values were found to be 71.2% and 18.8% for the light side and dark side, respectively.

To measure UV resistance, a Ci4000 Xenon Weather-Ometer (Atlas Material Testing Tech.) was used. A sample was irradiated at a 340 nm wavelength at 0.34 W/m². The total lamp output is 3.20 kW. On the light side, chalking appeared after 168 hours. At 212 hours there was complete failure of the woven structure. The black side showed no chalking or tendency to crack-on-bending for up to 480 hours.

Due to the relatively low UV resistance of the woven PP fabric, the exemplary underlayment is preferably left exposed for only relatively short durations, for example, a week to ten days, when installed woven-side-up. If a project requires longer durations of exposure, the underlayment may be installed with the pigmented spunbond fabric facing up. This will negate the cooling benefits of the woven PP fabric, but will allow for a much longer duration of exposure, for example, four months, before visible signs of degradation occur. This installation reversibility feature of the present invention allows a roofer to choose between installing the underlayment light-side-up or dark-side-up according to the needs of a particular job and/or locale. For example, in the southern region of the U.S., warmer weather and low precipitation typically permit a roof installation to be completed within a week or so, and a cooler work surface is highly desirable. On the other hand, in the northern region of the U.S., cooler temperatures and a higher frequency of inclement weather during certain times of the year make longer exposure a more important criteria than a cooler work surface.

Other advantages of the present invention over traditional felt underlayments include lighter weight and a longer life expectancy. The weight advantage allows the inventive underlayment to be packaged with about 4.5 squares (100 square feet) of underlayment per roll versus about 2 squares/roll for felt. The longer life is due to the inorganic nature of the preferred materials of the inventive underlayment, e.g., polypropylene outer layers and thermoplastic asphalt core, whereas felt underlayments comprise organic materials which tend to rot and deteriorate more rapidly.

In addition, whereas many underlayments are water vapor permeable, the underlayment of the present invention acts as a moisture barrier to protect the roof deck from water damage.

The following examples are presented to further illustrate the present invention and are not to be construed as unduly limiting the scope of the present invention.

### EXAMPLE #1

An underlayment material consisting of woven polypropylene (“PP”) with a weight of 70 g/m², spun bond PP with a weight of 43 g/m², and styrene butadiene rubber (“SBR”) modified asphalt with a softening point of 185° F. was tested. The material's characteristics and results are presented in Table #1. The inherent properties of the underlayment material in Example #1 are flexibility over a large temperature range, ease of roll-out, wrinkle resistant and anti-slip characteristics.

TABLE #1

| | |
|---|---|
| Basis Weight (per 100 square ft.) | 18-20 lbs |
| Thickness | 45 mils |
| Tensile Strength | |
| ASTM D5034 Machine Direction | 120 lbs. |
| ASTM D5034 Cross Direction | 110 lbs. |
| ASTM D4869 Machine Direction | 68 lbs. |
| ASTM D4869 Cross Direction | 54 lbs. |
| Liquid Water Transmission: ASTM D4869 | Pass |
| Taber Stiffness | |
| Machine Direction | 55 |
| Cross Direction | 55 |
| Nail Rip | |
| Machine Direction | 41 lbs. |
| Cross Direction | 36 lbs |
| Tear Resistance ASTM D828 | |
| Machine Direction | 2800 g |
| Cross Direction | 2800 g |
| Pliability ASTM D226, ½″ radius | Pass |
| Mullen Burst | >200 lbs. |

### EXAMPLE #2

An underlayment consisting of woven polypropylene (“PP”) with a weight of 90 g/m², spun bond PP with a weight of 43 g/m², and blown asphalt with an unknown softening point was tested. The material's characteristics and results are presented in Table #2. The inherent properties of the underlayment material in Example #2 is flexibility over a large temperature range, ease of roll-out, wrinkle resistant and anti-slip characteristics.

TABLE #2

| Basis Weight (per 100 square ft.) | 13.5 | lbs |
|---|---|---|
| Thickness | 35 | mils |
| Tensile Strength | | |
| ASTM D5034 Machine Direction | 130 | lbs. |
| ASTM D5034 Cross Direction | 140 | lbs. |
| ASTM D4869 Machine Direction | 80 | lbs. |
| ASTM D4869 Cross Direction | 79 | lbs. |
| Liquid Water Transmission: ASTM D4869 | Pass | |
| Taber Stiffness | | |
| Machine Direction | 80 | |
| Cross Direction | 70 | |
| Nail Rip | | |
| Machine Direction | 23 | lbs. |
| Cross Direction | 24 | lbs |
| Tear Resistance ASTM D828 | | |
| Machine Direction | >3200 | g |
| Cross Direction | >3200 | g |
| Pliability ASTM D226, ½″ radius | Pass | |
| Mullen Burst | >200 | lbs. |

### EXAMPLE #3

An underlayment consisting of woven polypropylene (“PP”) with a weight of 90 g/m², spun bond PP with a weight of 43 g/m², and blown asphalt with an unknown softening point was tested. The material's characteristics and results are presented in Table #3. The inherent properties of the underlayment material in Example #3 is flexibility over a large temperature range, ease of roll-out, wrinkle resistant and anti-slip characteristics.

TABLE #3

| | |
|---|---|
| Basis Weight (per 100 square ft.) | 11 lbs |
| Thickness | 38 mils |
| Tensile Strength | |
| ASTM D5034 Machine Direction | 140 lbs. |
| ASTM D5034 Cross Direction | 150 lbs. |
| ASTM D4869 Machine Direction | 76 lbs. |
| ASTM D4869 Cross Direction | 66 lbs. |
| Liquid Water Transmission: ASTM D4869 | Pass |
| Taber Stiffness | |
| Machine Direction | 77 |
| Cross Direction | 58 |
| Nail Rip | |
| Machine Direction | 37 lbs. |
| Cross Direction | 19 lbs |
| Tear Resistance ASTM D828 | |
| Machine Direction | >3200 g |
| Cross Direction | >3200 g |
| Pliability ASTM D226, ½″ radius | Pass |
| Mullen Burst | >200 lbs. |

### EXAMPLE #4

An underlayment consisting of a woven polypropylene (“PP”) outer fabric with a weight of 75 g/m²±25 g that can be pigmented or filled with a weave of 10 strands per inch by 10 strands per inch (which can vary) and a strand width of 0.97 inches. The open space between the strands should not exceed 10% of the total surface area. A spun bond PP outer layer fabric has a weight of 43 g/m²±20 g that can be pigmented as desired although in a preferred embodiment is pigmented black. The spun bond fabric is point bonded although it can be flat bonded. The inner core/binder is an asphalt stabilized with a styrene-butadiene-styrene (“SBS”) copolymer.

TABLE #4

| | |
|---|---|
| Basis Weight (per 100 square ft.) | 11 lbs. |
| Thickness | 38 mils. |
| Tensile Strength | |
| ASTM D5034 Machine Direction | 75 lbs. |
| ASTM D5034 Cross Direction | 75 lbs. |
| ASTM D4869 Machine Direction | 20 lbs. |
| ASTM D4869 Cross Direction | 20 lbs. |
| Nail Rip | |
| Machine Direction | 37 lbs. |
| Cross Direction | 20 lbs |
| Taber Stiffness | |
| Machine Direction | 75 |
| Cross Direction | 65 |
| Tear Resistance ASTM D828 | |
| Machine Direction | >3200 g |
| Cross Direction | >3200 g |
| Pliability ASTM D226, ½″ radius | Pass |
| Mullen Burst | >200 lbs. |

Those of ordinary skill in the art will appreciate that the foregoing discussion of certain embodiments and preferred embodiments are illustrative only, and does not limit the spirit and scope of the present invention, which is limited only by the claims set forth below.

1. A multiple-layered roofing underlayment material comprising:
an inner core comprising a continuous film water barrier;
a first outer layer comprising a woven or spun bond fabric; and
a second outer layer comprising a woven or spun bond fabric, wherein the inner core binds the first outer layer to the second outer layer.

2. The roofing underlayment material of claim 1 wherein said inner core comprises a thermoplastic asphalt composition.

3. The roofing underlayment material of claim 2 wherein said thermoplastic asphalt composition has a softening point of about 185 degrees Fahrenheit.

4. The roofing underlayment material of claim 1 wherein the first outer layer comprises a spun bond fabric and the second outer layer comprises a woven fabric.

5. The roofing underlayment of claim 4 wherein the first outer layer has a relatively low reflectivity and relatively high ultraviolet resistance, and the second outer layer has a relatively high reflectivity and relatively low ultraviolet resistance.

6. The roofing underlayment of claim 5 wherein the first and second outer layers comprise polypropylene.

7. The roofing underlayment of claim 5 wherein the first outer layer provides a deck-gripping surface and the second outer layer provides a walking surface during installation.

8. The roofing underlayment of claim 7 wherein the first and second outer layers comprise polypropylene.

9. The roofing underlayment material of claim 4 wherein said inner core comprises a thermoplastic asphalt composition.

10. The roofing underlayment material of claim 5 wherein said inner core comprises a thermoplastic asphalt composition.

11. The roofing underlayment material of claim 6 wherein said inner core comprises a thermoplastic asphalt composition.

12. The roofing underlayment material of claim 4 wherein the spun bond fabric has a weight of less than about 43 grams/m².

13. The roofing underlayment material of claim 4 wherein the woven fabric comprises polypropylene with a fabric weight of about 70 grams/m².

14. A three-layered roofing underlayment material comprising:
an inner core comprising a thermoplastic asphalt composition;
a first outer layer comprising a woven fabric having a relatively high reflectivity and relatively low ultraviolet resistance; and
a second outer layer comprising a non-woven fabric having a relatively low reflectivity and relatively high ultraviolet resistance, wherein the inner core binds the first outer layer to the second outer layer.

15. The roofing underlayment material of claim 14 wherein the woven fabric comprises polypropylene and the non-woven fabric is spun bond.

16. The roofing underlayment material of claim 15 wherein the non-woven fabric comprises polypropylene.
